(19) United States
(12) Patent Application Publication
(10) Pub. No.: US 2021/0237428 A1
(43) Pub. Date: Aug. 5, 2021

(54) RADIATIVE EMBOSSING WITH ENHANCING FLUID

(71) Applicant: Hewlett-Packard Development Company, L.P., Spring, TX (US)

(72) Inventors: Adam WEISMAN, San Diego, CA (US); Beverly CHOU, San Diego, CA (US); Or BRANDSTEIN, San Diego, CA (US)

(73) Assignee: Hewlett-Packard Development Company, L.P., Spring, TX (US)

(21) Appl. No.: 17/050,514

(22) PCT Filed: Jun. 15, 2018
(86) PCT No.: PCT/US2018/037768

§ 371 Date: Oct. 26, 2020

(51) Int. Cl. B41F 19/02; C09D 11/54; C09D 11/38; C09D 11/322; C09D 11/037; C09D 11/106

(52) U.S. Cl. CPC B41F 19/02; C09D 11/54; C09D 11/106; C09D 11/322; C09D 11/037; C09D 11/38

(57) ABSTRACT

The present disclosure is drawn to methods of embossing print media, printing systems, and printers. In one example, a method of embossing a print medium can include printing an enhancing fluid on a coated print medium to form a printed area. The enhancing fluid can include a colorless radiation absorbing agent capable of converting radiation having a wavelength from 200 nm to 400 nm to heat. A colored ink can also be printed on the print medium to form a visible image. The print medium can include a print substrate and an expanding coating layer on the print substrate. The expanding coating layer can include a thermal expansion agent having a minimum expansion temperature. The coated print medium can be irradiated with radiation having a wavelength from 200 nm to 400 nm to selectively heat the printed area and expand the thermal expansion agent in the printed area.

### BACKGROUND

The tactile and visual appearance of textured or embossed media can enhance the value of printed graphics in many industries, such as home decor, signage, scrapbooking, brochures, and so on. Textured and embossed printing media is often made using a stamp, plate, or similar mechanical device. For example, a piece of media such as a sheet of paper can be placed between a positive embossing plate and a negative embossing plate. Pressure can then be applied to the embossing plates to press an embossed pattern into the paper. In another method, paper can be rolled between a positive embossing roller and a negative embossing roller. Similar methods can be used to form fine textures in paper. Such methods can often have a high up-front cost of making the embossing or textured rollers or plates. Making embossed or texture rollers or plates can also be time consuming, so that these methods are often relegated to applications where a large quantity of textured or embossed media is to be made with a single textured or embossed design.

### BRIEF DESCRIPTION OF THE DRAWINGS

FIG. 1 is a flowchart of a method of embossing a print medium, in accordance with an example of the present disclosure;

FIG. 2 is a schematic view of an example coated print medium with an enhancing fluid and a colored ink printed on the coated print medium, in accordance with an example of the present disclosure;

FIG. 3 is a schematic view of an example coated print medium being embossed by irradiating the coated print medium, in accordance with an example of the present disclosure;

FIG. 4 is a schematic view of another example coated print medium having an enhancing fluid printed on a back surface and a colored ink printed on a front surface, in accordance with an example of the present disclosure;

FIG. 5 is a schematic view of an example coated print medium being embossed by irradiating the coated print medium, in accordance with an example of the present disclosure;

FIG. 6 is a schematic view of yet another example coated print medium, in accordance with an example of the present disclosure;

FIG. 7 is a schematic view of another example coated print medium, in accordance with an example of the present disclosure;

FIG. 8 is a schematic view of an example printing system, in accordance with an example of the present disclosure; and

FIG. 9 is a schematic view of an example printer, in accordance with an example of the present disclosure.

### DETAILED DESCRIPTION

The present disclosure is drawn to radiative embossing methods and systems for embossing print media using an enhancing fluid. In one example, a radiative embossing method can include printing an enhancing fluid on a coated print medium to form an enhancing fluid-printed area. The enhancing fluid can include a colorless radiation absorbing agent capable of converting radiation having a wavelength from 200 nm to 400 nm to heat. The method can also include printing a colored ink on the coated print medium to form a visible image. The coated print medium can include a print substrate and an expanding coating layer on the print substrate. The expanding coating layer can include a thermal expansion agent having a minimum expansion temperature. The method can further include irradiating the coated print medium with radiation having a wavelength from 200 nm to 400 nm to selectively heat the enhancing fluid-printed area and expand the thermal expansion agent in the enhancing fluid-printed area.

In further examples, the coated print medium can also include an ink receiving layer on the expanding coating layer. In one example, the ink receiving layer can include a first crosslinked polymeric network and a second crosslinked polymeric network that is a different polymer from the first crosslinked polymeric network. In another example, the ink receiving layer can include inorganic pigment particles and a binder including polyvinyl alcohol.

In certain examples, the colorless radiation absorbing agent can include bisoctrizole, avobenzone, bisdisulizole disodium, diethylamino hydroxybenzoyl hexyl benzoate, a benzotriazole, a benzophenone, a triazine, other UVA absorbing agents, or combinations thereof.

In a further example, the method can include heating the coated print medium using a heater such that the enhancing fluid-printed area and unprinted area reach a first temperature from 5° C. to 90° C. below the minimum expansion temperature of the thermal expansion agent prior to irradiating.

In still further examples, the expanding coating layer can include a flexible polymeric binder and the thermal expansion agent can include temperature responsive thermoplastic beads in the flexible polymeric binder. The temperature responsive thermoplastic beads can include a propellant encapsulated in a thermoplastic polymer shell. In some examples, the thermoplastic polymer shell can have a glass transition temperature form 90° C. to 200° C. and the flexible polymeric binder can have a glass transition temperature that is below the glass transition temperature of the thermoplastic polymer shell. In further examples, the propellant can be a hydrocarbon liquid having a boiling point from 90° C. to 200° C.

In other examples, the expanding coating layer can be on a front surface of the coated print medium. The enhancing fluid and colored ink can both be printed on the front surface of the coated print medium prior to the irradiating of the coated print medium. In yet other examples, the expanding coating layer can be on a front surface of the coated print medium and the enhancing fluid can be printed on the front surface. The coated print medium can be irradiated prior to printing the colored ink. The colored ink can be printed on the front surface after the thermal expansion agent in the enhancing fluid-printed area has expanded. In another example, the enhancing fluid can be printed on a back surface of the coated print medium and the colored ink can be printed on a front surface of the coated print medium. The irradiating can be performed on the back surface of the coated print medium. In a further example, the coated printed medium can also include an enhancing fluid-receiving layer on the back surface but can not include an expanding coating layer on the back surface of the print substrate.

The present disclosure also extends to radiative embossing printing systems. In one example, a printing system can include a printer, a radiation emitter, and a coated print medium to load in the printer. The printer can include a reservoir of an enhancing fluid. The enhancing fluid can include a colorless radiation absorbing agent capable of converting radiation having a wavelength from 200 nm to 400 nm to heat. The printer can also include a reservoir of a colored ink, a first print head in communication with the reservoir of enhancing fluid, and a second print head in communication with the reservoir of colored ink. The radiation emitter can have a peak wavelength from 200 nm to 400 nm. When the coated print medium is loaded in the printer, the radiation emitter can be positioned to expose a surface of the coated print medium to the radiation after the enhancing fluid is printed. The coated print medium can include a print substrate and an expanding coating layer on the print substrate. The expanding coating layer can include a thermal expansion agent having a minimum expansion temperature. In a further example, the system can include a heater to heat the coated print medium to a first temperature from 5° C. to 90° C. below the minimum expansion temperature of the thermal expansion agent.

The present disclosure also extends to radiative embossing printers. In one example, a printer can include a reservoir of an enhancing fluid. The enhancing fluid can include a colorless radiation absorbing agent capable of converting radiation having a wavelength from 200 nm to 400 nm to heat. The printer can also include a reservoir of a colored ink, a first inkjet print head in communication with the reservoir of enhancing fluid, and a second inkjet print head in communication with the reservoir of colored ink. A media feeder can be positioned to feed a print medium through a print path of the inkjet print heads. A radiation emitter having a peak wavelength from 200 nm to 400 nm can be positioned to irradiate the print medium after the enhancing fluid is printed on the print medium. In a further example, the printer can include a heater positioned to heat the print medium prior to or concurrent with the irradiating of the print medium.

The methods and systems for embossing coated print media described herein can be used to provide easily customizable embossing. Digital printing methods, such as inkjet printing, have allowed for unique and customized printing of images on many substrates. However, there have previously been limited solutions to provide unique and customized texture or embossing in digital printing applications. Additionally, the cost of mechanical embossing equipment can be prohibitive to small scale production of digitally generated content like that typically produced from inkjet printers. Also, the scope of coated substrates that may be mechanically embossed is limited to those possessing the appropriate physical properties, whereas the scope of coated substrates which can currently be printed is greater and growing. Few methods to digitally control texture or embossing of inkjet printed graphics exist, and these can utilize special printers and/or inks that are not universally compatible with current and future inkjet platforms. Herein, a coating design and embossing process is disclosed that will allow digital control of embossing on different substrates for graphics applications. This solution provides compatibility with current and future small and large format inkjet printing platforms without specialty ink formulations.

In some examples, a coated print medium can include an expanding coating layer that can expand in response to an elevated temperature. The medium can be embossed by applying heat to specific areas of the medium, causing the expanding coating to increase in volume in those areas. This can create raised designs on the medium. In some examples, the medium can be heated using electromagnetic radiation. Specifically, radiation having a wavelength from 200 nm to 400 nm can be used in some examples. These wavelengths can be absorbed and converted to heat by a variety of radiation absorbing materials, including some pigments and dyes used in colored inks. The embossed design can therefore be formed, in certain examples, by printing a radiation absorbing material to the medium and then irradiating the medium to selectively heat the medium in the printed areas.

Using radiation in the wavelength band from 200 nm to 400 nm can provide spatial specificity to the embossed patterns, because radiation within this wavelength range is not absorbed at a significant rate by blank print media. Thus, irradiating a print medium having a design printed with an ink that absorbs the radiation can specifically emboss the printed areas while the unprinted areas remain flat and unembossed.

In some examples, colored inks can absorb sufficient radiation to trigger the expansion of the expanding coating layer. Thus, a graphic image printed with colored inks (i.e., cyan, magenta, yellow, black, or other colors, for example) can be exposed to radiation having a wavelength from 200 nm to 400 nm to selectively emboss the areas printed with colored ink. However, in some cases the height of the embossed areas can vary depending on the ink density printed in the area. An area with a high ink density can reach a greater embossing height than areas with lower ink density because the higher ink density area heats up more due to more absorption of the radiation. When the high ink density area heats up to a higher temperature, the thermal expansion agents in the expanding coating layer can expand more than in the areas with lower ink density. Graphic images can have a wide variety of ink density in different areas of the image. Thus, an uneven embossed surface can result.

The present disclosure describes an enhancing fluid that can be used together with colored inks to provide more control over the embossing height than using colored ink alone. For example, the enhancing fluid can be printed in areas with lower ink density to increase the amount of radiation absorbed in those areas. The overall amount of absorbed radiation can be matched to higher ink density areas to provide a more even embossing height. Alternatively, if a particular embossed pattern is desired that does not correspond to the graphic image, then enhancing fluid can be printed to form an embossed pattern independent of the graphic image printed in colored ink. Additionally, some colored inks may absorb less radiation than other colored inks. This can be due to the differing absorptivity of different pigments and dyes. Therefore, in some cases enhancing fluid can be printed in the same areas where colors having lower absorptivity are printed, to allow those areas to be embossed to the same embossing height as other areas printed with colors having higher absorptivity. Finally, the enhancing fluid can be colorless so that the enhancing fluid can be printed on the same surface of the print media as the graphic image without interfering with the appearance of the graphic image.

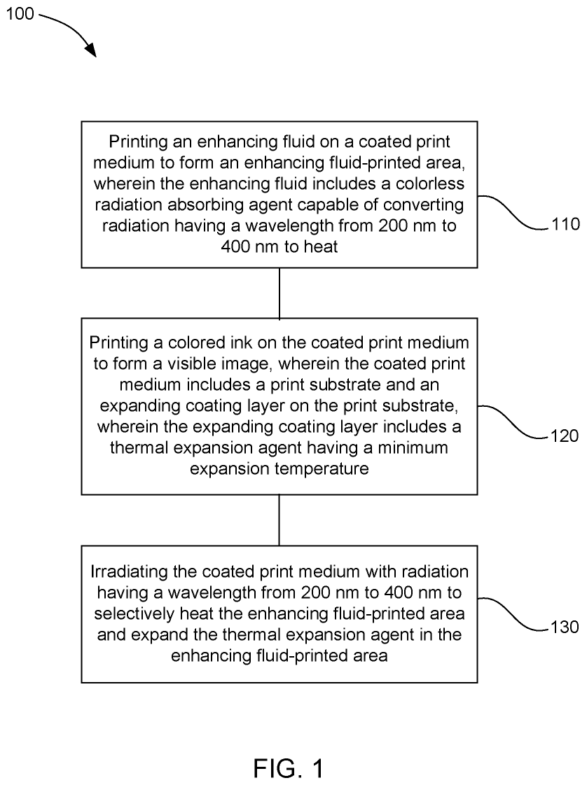

With this description in mind, FIG. 1 is a flowchart of an example method 100 of embossing a print medium. The method includes: printing 110 an enhancing fluid on a coated print medium to form an enhancing fluid-printed area, wherein the enhancing fluid includes a colorless radiation absorbing agent capable of converting radiation having a wavelength from 200 nm to 400 nm to heat; printing 120 a colored ink on the coated print medium to form a visible image, wherein the coated print medium includes a print substrate and an expanding coating layer on the print substrate, wherein the expanding coating layer includes a thermal expansion agent having a minimum expansion temperature; and irradiating 130 the coated print medium with radiation having a wavelength from 200 nm to 400 nm to selectively heat the enhancing fluid-printed area and expand the thermal expansion agent in the enhancing fluid-printed area.

The embossing processes described herein can be enabled by the expanding coating layer on the coated print medium. This layer can include a thermal expansion agent that can expand (i.e., increase in volume) in response to an increase in temperature. In some examples, the thermal expansion agent can have a minimum expansion temperature. Below the minimum expansion temperature, the thermal expansion agent does not expand but retains its original volume. In further examples, the thermal expansion agent to can expand to a higher degree at temperatures higher than the minimum expansion temperature. Thus, the embossing height of an embossed image can in some examples be controlled by increasing the temperature of the thermal expansion agent to a temperature above the minimum expansion temperature.

In some examples, the thermal expansion agent can include temperature responsive thermoplastic beads. These can be small particles made up of a propellant encapsulated in a thermoplastic polymer shell. When the temperature responsive thermoplastic beads are heated to a minimum expansion temperature, the beads can expand due to a combination of softening of the thermoplastic polymer shell and increasing pressure of the propellant. In some examples, the propellant can be a liquid that has a boiling point at or below the minimum expansion temperature.

In further examples, the thermal expansion agent can include a blowing agent dispersed in a polymer coating. In some cases, blowing agents can increase in volume through phase change or chemical decomposition when the blowing agents reach the minimum expansion temperature.

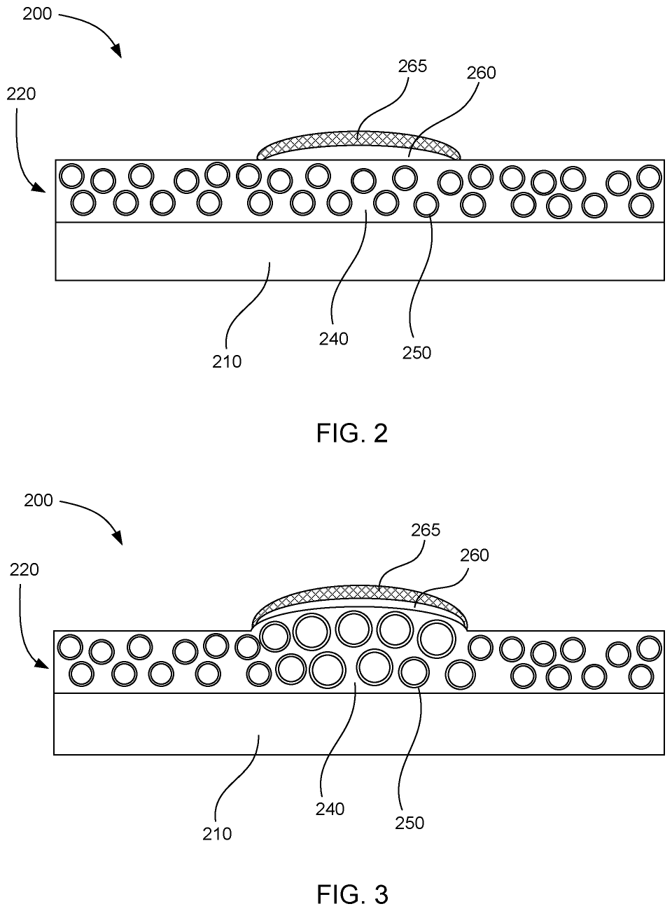

To illustrate the embossing process using enhancing fluid in conjunction with colored ink, FIG. 2 shows an example coated print medium 200. In this example, the coated print medium includes a print substrate 210 and an expanding coating layer 220 on the print substrate. The thermal expansion agent in this example is temperature responsive thermoplastic beads 250. The beads are dispersed in a matrix of a flexible polymeric binder 240. An enhancing fluid 260 has been printed on an area of the medium together with a colored ink 265. The enhancing fluid can include a colorless radiation absorbing agent capable of converting radiation having a wavelength from 200 nm to 400 nm to heat.

FIG. 3 shows the coated print medium 200 again after being irradiated with radiation having a wavelength from 200 nm to 400 n. This radiation can be absorbed and converted to heat by the enhancing fluid 260 to heat the temperature responsive thermoplastic beads 250 up to the minimum expansion temperature. Thus, the temperature responsive thermoplastic beads expand in the area where the radiation absorbing ink is printed, but not in the unprinted areas. The expansion causes the surface of the coated print medium to rise, creating an embossed design.

Although the enhancing fluid is still referred to as a “fluid” in FIG. 3, in some examples the enhancing fluid can actually become dry due to the heat generated during irradiation. Thus, solvents in the enhancing fluid can evaporate and leave behind the absorbing agents and other non-evaporable components of the enhancing fluid. In other examples, the enhancing fluid can dry even before the irradiation occurs. Similarly, the colored ink can dry before or during the irradiation to form a dried colored ink on the surface of the coated print medium.

In certain examples, the coated print medium can also include an ink receiving layer that can adhere and fix the enhancing fluid and colored inks that are printed on the medium. An ink receiving layer can be applied over the expanding coating layer in some examples. In other examples, an expanding coating layer can be applied to a front surface of the print substrate and an ink receiving layer can be applied to a back surface of the print substrate. In still further examples, ink receiving layers can be applied to both front and back surfaces of the print medium.

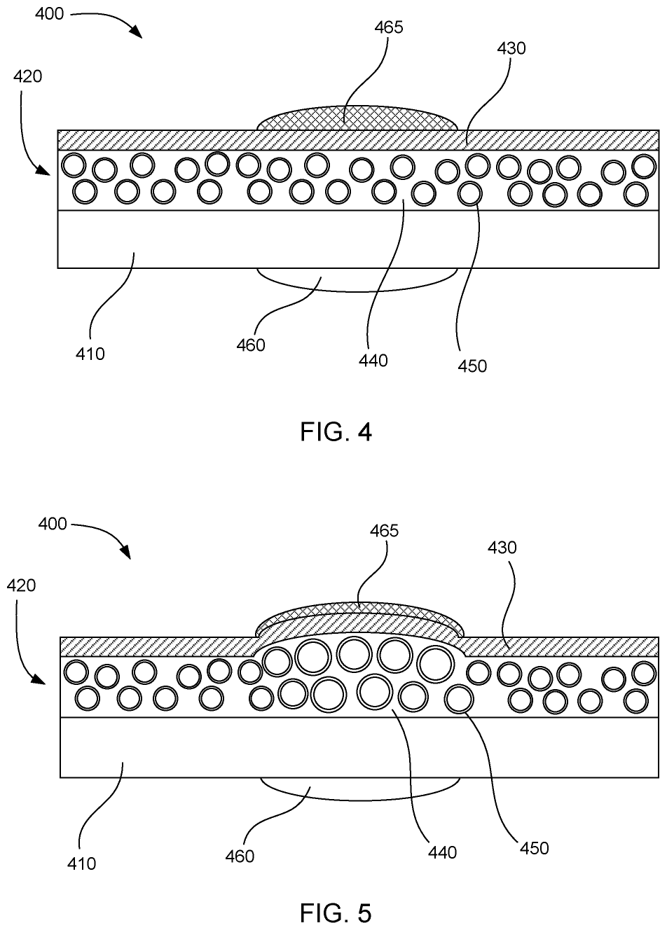

As used herein, “colored ink” refers to an ink having a color that is visible to the human eye. For example, colored inks can include black inks, cyan inks, magenta inks, yellow inks, and inks of a variety of other visible colors. In some examples, the enhancing fluid can be printed together with colored ink on a front surface of the coated print medium. In further examples, the enhancing fluid can be printed on a back surface of the print medium and then an image can be printed with colored ink on a front surface of the print medium. This arrangement is shown in FIG. 4. In this example, a coated print medium 400 includes a print substrate 410, and expanding coating layer 420, and an ink receiving layer 430. The expanding coating layer includes a flexible polymeric binder 440 and temperature responsive thermoplastic beads 450 in the flexible polymeric binder. The enhancing fluid 460 is printed on a back surface of the print medium and a colored ink 465 is printed on a front surface of the print medium.

FIG. 5 shows the coated print medium 400 after being irradiated with radiation having a wavelength from 200 nm to 400 nm. In this example, the back surface of the print medium can be irradiated so that the enhancing fluid 460 can absorb the radiation. In this figure, the temperature responsive thermoplastic beads 450 have expanded in the area where the enhancing fluid was printed on the back surface of the print medium. In some examples, the radiation can be applied to the surface of the print medium on which the enhancing fluid is printed. Thus, when the enhancing fluid is printed on the back surface of the print medium, the medium can be irradiated from behind. Similarly, when the enhancing fluid is printed on the front surface, the medium can be irradiated from the front.

With this description in mind, in some examples a coated print medium can include a variety of print substrates. In certain examples, the print substrate can include a paper based material. As used herein, “paper” refers to material produced by pressing together moist fibers. This can include paper made of natural fibers, synthetic fibers, or some combination of these. Paper materials can also include fillers, binders, and other additives, as well as any combination thereof.

In further examples, the substrate can include a fabric structure. As used herein, “fabric” can mean a textile, a cloth, a fabric material, fabric clothing, or another fabric product. The term “fabric structure” is intended to mean a structure having warp and weft that can be woven, non-woven, knitted, tufted, crocheted, knotted, and/or pressured, for example. The terms “warp” and “weft” refer to weaving terms that have their ordinary means in the textile arts, as used herein, e.g., warp refers to lengthwise or longitudinal yarns on a loom, while weft refers to crosswise or transverse yarns on a loom. The fabric substrate can include one or both of natural fibers and synthetic fibers.

In still further examples, the print substrate can include a film. The term “film” can refer to any continuous polymeric material that is be extruded or cast. The film can include a polymer material or multiple polymer materials or multiple layers of the same or different polymeric materials or mixtures of polymers. The film can also include fillers and additives which modify its chemical or mechanical properties. A film can also include another material laminated with a polymeric film.

The coated print media described herein can also include an expanding coating layer on the print substrate. In some examples, the expanding coating can include a thermal expansion agent. In certain examples, the thermal expansion agent can be temperature responsive thermoplastic beads which can be incorporated in a flexible polymer matrix. In this case, the term “bead” can be defined as a microparticle including a polymer shell encapsulating a propellant. In some examples, the beads can have an unexpanded average particle size from 2 to 50 microns. In certain examples, the beads can have an unexpanded average particle size from 5 to 15 microns. As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. When the beads are heated, molecular motion of the propellant increases, generating an internal pressure at the core of the beads. Heating can also serve to soften the thermoplastic polymer shell. The combined effect of the polymer shell softening, and increasing internal pressure from the propellant, result in an expansion of the particle diameter. Once the heat is removed the thermoplastic polymer hardens and retains the new diameter. In some examples, the beads can have an expanded diameter from 10 microns to 150 microns. In certain examples, the final diameter of the beads can be influenced by the amount of heating provided. For example, heating the beads to a higher temperature can result in a larger final diameter.

Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

In certain examples, the shell of the temperature responsive thermoplastic beads can include a polymer or copolymer material with a glass transition temperature (Tg) from 90° C. to 200° C. In various examples, the polymer(s) can be synthesized from monomers including; vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or mixtures thereof.

Glass transition temperature can be measured using differential scanning calorimetry according to ASTM D6604: Standard Practice for Glass Transition Temperatures of Hydrocarbon Resins by Differential Scanning Calorimetry. Differential scanning calorimetry can be used to measure the heat capacity of the polymer across a range of temperatures. The heat capacity can jump over a range of temperatures around the glass transition temperature. The glass transition temperature itself can be defined as the temperature where the heat capacity is halfway between the initial heat capacity at the beginning of the jump and the final heat capacity at the end of the jump.

The propellant encapsulated within the shell can be a liquid that can expand or increase pressure inside the shell when heated. In some examples, the propellant can include a liquid which readily evaporates at a boiling point from 90° C. to 200° C. Non-limiting examples of propellants which can be used include hydrocarbons such as methane, ethane, propane, isobutane, n-butane, isooctane, and isopentane, or combinations thereof.

Boiling point can be measured using differential scanning calorimetry. The liquid being tested can be slowly heated through a range of temperatures at a pressure of 1 atm. The heat flow into the liquid (i.e., amount of energy in Joules that is added to the liquid) can be measured and plotted against the temperature of the fluid. When the liquid boils, heat will continuously flow into the liquid without a change in temperature, creating a vertical spike in the plot (with the heat flow on the y-axis and the temperature on the x-axis of the plot). The temperature at which this occurs is the boiling point.

Non-limiting examples of commercial grade temperature responsive thermoplastic beads include; Advancell EM™ EML101™ EML204™, EML301 ™, EM302™, EML303™, EML304™, EML401™ and other Advencell EM™ products from Sekisui Chemical CO.; Prolite™ 15, Prolite™ 25, Prolite™ 35, Prolite™ 50, and other Prolite™ products from R.J. Marshall CO.; Expancel™ 551 DU 40™, 461DU20™, 461 DU40™, 051 DU40™, 031 DU40™, 053 DU40™, 093 DU 120™, 909 DU80™, 920 DU40™, 920 DU80™, 920 DU120™, 930 DU 120™, 950 DU80™, 951 DU120™, 980 DU120™, and other wet, dry or slurry forms of Expancel™ products from AzkoNobel; expanding polymer beads from Nanosphere; and others.

In some examples, the temperature responsive thermoplastic beads can be present in the expanding coating layer in an amount from 20 wt % to 70 wt % by total dry weight of the expanding coating layer.

The expanding coating layer can also include a flexible polymeric binder. The flexible polymer binder can bind the temperature responsive thermoplastic beads as well as any other additives and fillers that may be in the expanding coating layer. The flexible polymeric binder can also promote adhesion to the substrate and provide adhesion for the image receiving layer. In some examples, the polymeric binder can be present in the expanding coating layer in an amount from 10 wt % to 80 wt % by total dry weight of the expanding coating layer.

In some examples, the polymeric binder can include a water-soluble polymer or an aqueous dispersion such as a latex polymer. In certain examples, the polymer can form a film upon curing. The polymeric binder can include a synthetic polymer, a natural polymer, or a combination thereof. The polymer binder can provide a flexible matrix for the temperature responsive thermoplastic beads, allowing for expansion of the beads without compromising the integrity of the coating. In some cases, the flexible polymeric binder can include an elastomeric polymer with a Tg below that of the thermoplastic shell of the beads. In certain examples, the flexible polymeric binder can have a Tg from −40° C. to 120° C. In further examples, the polymeric binder can have a glass transition temperature (Tg) from −40° C. to 0° C. In other examples, the polymeric binder can have a glass transition temperature (Tg) from −20° C. to −5° C.

In some examples, the flexible polymeric binder can include a cross-linked polymer. As used herein, “crossed-linked” refers to a polymer in which reactive functional groups on the polymer chain have reacted to form structures linking multiple polymer chains together at locations along the length of the chains. In some examples the cross-linking can be formed by adding a cross-linker such as a molecule having two or more functional groups that can react with functional groups on the polymer chains. In other examples, the flexible polymeric binder can include a self-cross-linking polymer that has cross-links formed by direct reaction of functional groups on the polymer chains. In some examples, cross-linked binders can balance elasticity and mechanical strength of the coating layers.

Suitable flexible polymeric binders can include, but are not limited to, polyvinyl alcohol, starch derivatives, gelatin, cellulose derivatives, acrylamide polymers, acrylic polymers or copolymers, vinyl acetate latex, polyesters, vinylidene chloride latex, styrene-butadiene copolymers, acrylonitrile-butadiene copolymers, polyacrylates, polyvinylacetates, polyacrylic acids, polystyrene, polymethacrylates, polyacrylic esters, polymethacrylic esters, polyurethanes, copolymers thereof, and combinations thereof. In certain examples, the binder can be an acrylic polymer or copolymer, vinyl acetate polymer or copolymer, polyester polymer or copolymer, vinylidene chloride polymer or copolymer, butadiene polymer or copolymer, styrene-butadiene polymer or copolymer, or acrylonitrile-butadiene polymer or copolymer. In a further example, the polymeric binder can include an acrylonitrile-butadiene latex.

In further examples, the flexible polymeric binder can include latex particles such as a vinyl acetate-based polymer, an acrylic polymer, a styrene polymer, a styrene-butadiene rubber (SBR)-based polymer, a polyester-based polymer, a vinyl chloride-based polymer, or the like. In yet other examples, the binder can be a copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. In still further examples, the flexible polymeric binder can include polyvinyl alcohols or water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; or combinations thereof. In certain examples, the flexible polymeric binder can include polymerized monomers including vinyl chloride, vinylidene chloride, acrylonitrile, methacrylonitrile, methyl methacrylate, styrene, o-chlorostyrene, vinyl acetate, butyl acrylate, esters of acrylic acid, esters of methacrylic acid, or combinations thereof.

In one example, the flexible polymeric binder can be a polymer having a weight average molecular weight (Mw) of about 5,000 to about 200,000. In another example, the weight average molecular weight of the binder can vary from 10,000 Mw to about 200,000 Mw. In yet another example, the weight average molecular weight of the binder can be from 20,000 Mw to 100,000 Mw. In a further example, the weight average molecular weight of the polymeric binder can be from 100,000 Mw to 200,000 Mw. In one example, the polymeric binder can have a weight average molecular weight from 5,000 Mw to 200,000 Mw and can include polystyrene-butadiene emulsion, acrylonitrile butadiene latex, starch, gelatin, casein, soy protein polymer, carboxy-methyl cellulose, hydroxyethyl cellulose, acrylic emulsion, vinyl acetate emulsion, vinylidene chloride emulsion, polyester emulsion, polyvinyl pyrroilidene, polyvinyl alcohol, styrene butadiene emulsions, or combinations thereof.

In further examples, the thermal expansion agent can be a blowing agent. The blowing agent can be dispersed in a polymer matrix. A blowing agent can be defined as a substance which can be converted from a liquid or solid state into a gas via a phase change or decomposition, respectively. The evolved gas serves to increase the local pressure within the coating of and causes a volume expansion of the material. Substances which may be used include; hydrocarbons such as those listed as propellants above, azodicarbonamide (ADC; 170-200C), sulfonyl hydrazide's (OBSH, TSH; 143-165C), benzenesulfonyl hydrazide (BSH; 90-105C), or any mixture or solution containing these compounds.

The expanding coating layer can also contain other additives and fillers including, but not limited to; whitening agents such as optical brighteners or TiO₂; wetting agents, film formation, and adhesion; dispersants to reduce settling and aggregation of insoluble fillers; de-foaming agents to reduce foam formation, rheology modifiers to reduce settling of fillers; other non-elastomeric binders, adhesives, or plasticizers to modify mechanical properties; fire retardant chemicals; fillers or chemicals which modify the materials thermal properties or thermal transfer characteristics; and so on. In some examples, additives and fillers can be present in the expanding coating layer in an amount from 1 wt % to 50 wt % with respect to the total dry weight of the expanding coating layer.

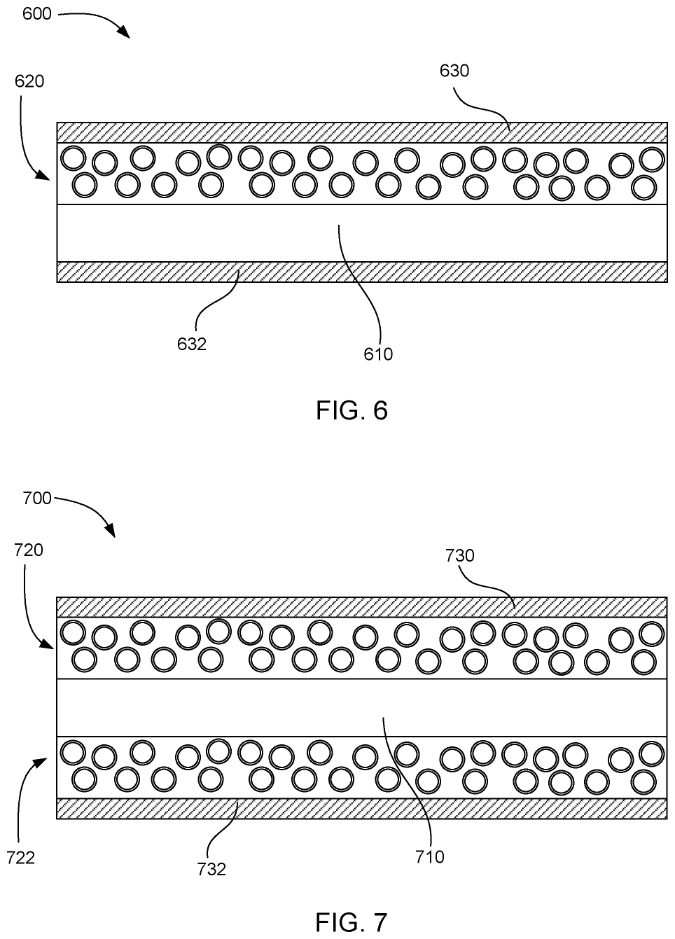

In some examples, an ink receiving layer can be applied over the expanding coating layer. In certain examples, the ink receiving layer can be applied to a front surface of the print medium but not to the back surface. In another example, a second ink receiving layer can be applied to the back surface of the print medium. FIG. 6 shows an example coated print medium 600 that includes a print substrate 610, an expanding coating layer 620 on a front surface of the print substrate, an ink receiving layer 630 on the expanding coating layer, and a second ink receiving layer 632 on a back surface of the print substrate. In this example, a radiation absorbing ink and/or colored ink can be printed on the second ink receiving layer on the back surface of the print medium.

FIG. 7 shows another example coated print medium 700. This example includes a print substrate 710, a first expanding coating layer 720 on a front surface of the print substrate, and a first ink receiving layer 730 on the first expanding coating layer. A second expanding coating layer 722 is on a back surface of the print substrate. A second ink receiving layer 732 is on the second expanding coating layer. In this example, radiation absorbing ink and/or colored ink can be printed on both front and back surfaces of the print medium, and embossed patterns can be formed on both the front and back surfaces by expanding the first and second expanding coating layers.

In some examples, the ink receiving layer can be designed to provide good printing properties for the specific type of ink to be printed on the print medium. In one example, the ink receiving layer can be designed to receive latex-based inks. In some such examples, the ink receiving layer can include a crosslinked polymer network or multiple crosslinked polymer networks that form a continuous film. In some examples, the crosslinked polymer network can have a Tg at or below 120° C., such as from 20° C. to 120° C. In certain examples, the ink receiving layer can include a first crosslinked polymeric network and a second crosslinked polymeric network, both having a glass transition temperature from 20° C. to 120° C. In further examples, the first and second crosslinked polymeric networks can include a polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivative thereof, or combination thereof. In some examples, the first and second crosslinked polymeric networks can be different polymers.

In one example, the first and/or second crosslinked polymeric network can include a polyacrylate. Polyacrylate-based polymers can include polymers made by hydrophobic addition monomers including, but not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethyl hexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives can also be used. In one example, the polyacrylate based polymer can include polymers having a glass transition temperature from 20° C. to 120° C. In another example, the polyacrylate based polymer can include polymers having a glass transition temperature from 40° C. to 120° C. In yet another example, the polyacrylate based polymer can include polymers having a glass transition temperature from 50° C. to 120° C.

In one example, the first or second crosslinked polymeric network can include a polyurethane polymer. The polyurethane polymer can be hydrophilic. The polyurethane can be formed in one example by reacting an isocyanate with a polyol. Isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commercially available isocyanates can include Rhodocoat™ WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). The polyol reacted with the isocyanate can include 1,4-butanediol, 1,3-propanediol, 1,2-ethanediol, 1,2-propanediol, 1,6-hexanediol; 2-methyl-1,3-propanediol, 2,2-dimethyl-1,3-propanediol, neopentyl glycol; cyclohexanedimethanol; 1,2,3-propanetriol, 2-ethyl-2-hydroxymethyl-1,3-propanediol, or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having two or more isocyanate functionalities and a polyol having two or more hydroxyl or amine groups.

In a particular example, a polyurethane prepolymer can be prepared with a NCO/OH ratio from 1.2 to 2.2. In another example, the polyurethane prepolymer can be prepared with a NCO/OH ratio from 1.4 to 2.0. In yet another example, the polyurethane prepolymer can be prepared using an NCO/OH ratio from 1.6 to 1.8.

In one example, the weight average molecular weight of the polyurethane prepolymer can range from about 20,000 Mw to about 200,000 Mw as measured by gel permeation chromatography. In another example, the weight average molecular weight of the polyurethane prepolymer can range from about 40,000 Mw to about 180,000 Mw as measured by gel permeation chromatography. In yet another example, the weight average molecular weight of the polyurethane prepolymer can range from about 60,000 Mw to about 140,000 Mw as measured by gel permeation chromatography.

Non-limiting examples of polyurethane polymers can include polyester based polyurethanes, U910™, U938™, U2101™ and U420™; polyether based polyurethane, U205™, U410™, U500™ and U400N™; polycarbonate based polyurethanes, U930™, U933™, U915™ and U911™; castor oil based polyurethane, CUR21™ CUR69™, CUR99™ and CUR991™ and combinations thereof. (All of these polyurethanes are available from Alberdingk Boley Inc., North Carolina).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, or combinations thereof. Commercially-available examples of these polyurethanes can include; NeoPac® R-9000, R-9699, and R-9030 (available from Zeneca Resins, Ohio), Printrite™ DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure®12471, (all commercially available from available from Lubrizol Advanced Materials, Inc., Ohio), or combinations thereof.

In some examples, the polyurethane can be cross-linked using a cross-linking agent. In example, the cross-linking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the first or second crosslinked polymeric network can include an epoxy. The epoxy can be an alkyl epoxy resin, an alkyl aromatic epoxy resin, an aromatic epoxy resin, epoxy novolac resins, epoxy resin derivatives, and combinations thereof. In some examples, the epoxy can include an epoxy functional resin having one, two, three, or more pendant epoxy moieties. Example epoxy functional resins can include Ancarez® AR555 (commercially available from Air Products and Chemicals Inc., Pennsylvania), Ancarez® AR550, Epi-rez™ 3510W60, Epi-rez™ 3515W6, Epi-rez™ 3522W60 (all commercially available from Hexion, Tex.) and combinations thereof. In some examples, the epoxy resin can be an aqueous dispersion of an epoxy resin. Example commercially available aqueous dispersions of epoxy resins can include Araldite® PZ3901, Araldite® PZ3921, Araldite® PZ3961-1, Araldite® PZ323 (commercially available from Huntsman International LLC, Texas), Waterpoxy® 1422 (commercially available from BASF, Germany), Ancarez® AR555 1422 (commercially available from Air Products and Chemicals, Inc., Pennsylvania), and combinations thereof. In yet another example, the epoxy resin can include a polyglycidyl or polyoxirane resin.

In one example, the epoxy resin can be self-crosslinked. Self-crosslinked epoxy resins can include polyglycidyl resins, polyoxirane resins, and combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resins hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, and combinations thereof. Example commercially available epoxy resin hardeners can include Anquawhite™ 100 (commercially available from Air Products and Chemicals Inc., Pennsylvania), Aradur® 3985 (commercially available from Huntsman International LLC, Texas), Epikure™ 8290-Y-60 (commercially available from Hexion, Tex.), and combinations thereof.

In one example, the first or second crosslinked polymeric network can include an epoxy resin and the epoxy resin can include a water based epoxy resin and a water based polyamine. In another example, the first or second crosslinked polymeric network can include a vinyl urethane hybrid polymer, a water based epoxy resin, and a water based polyamine epoxy resin hardener. In yet another example, the first or second crosslinked polymeric network can include an acrylic-urethane hybrid polymer, a water based epoxy resin, and a water based polyamine epoxy resin hardener.

In some examples, the first crosslinked polymeric network can be crosslinked to itself. In another example, the first crosslinked polymeric network can be crosslinked to itself and to the second crosslinked polymeric network. In one example, the second crosslinked polymeric network can be crosslinked to itself. When the first crosslinked polymeric network and the second crosslinked polymeric network are not crosslinked to one another they can be entangled or appear layered onto one another.

The first and second crosslinked polymeric networks can be present in the image receiving layer in a variety of amounts. In one example, the first and second crosslinked polymeric networks can collectively make up from about 80 wt % to about 99 wt % of the ink receiving layer. In another example, the first and second crosslinked polymeric networks can collectively make up about 80 wt % to about 97 wt % of the ink receiving layer. In yet another example, the first and second crosslinked polymeric networks can collectively make up from about 85 wt % to about 95 wt % of the ink receiving layer. In a further example, the first and second crosslinked polymeric networks can collectively make up from about 85 wt % to about 93 wt % of the secondary coating layer. In some examples the first and second crosslinked polymeric networks can be present in equal amounts. In other examples the first and second crosslinked polymeric networks can be present in different amounts.

In some examples, the process of applying the ink receiving layer can include a floating knife process, a knife on roll mechanism process, or a transfer coating process.

Ink receiving layers designed for latex ink can also contain other additives and fillers including but not limited to; waxes to increase durability; whitening agents such as optical brighteners or TiO₂; wetting agents, film formation, and adhesion; dispersants to reduce settling and aggregation of insoluble fillers; de-foaming agents to reduce foam formation, rheology modifiers to reduce settling of fillers; other non-elastomeric binders, adhesives, or plasticizers to modify mechanical properties; fire retardant chemicals; physical or chemical absorbing agents which modify the materials thermal properties or radiative absorption; and so on.

In one example, the image receiving layer can be applied to the substrate at a dry coat weight of from 1 gsm to 30 gsm. In another example, the dry coat weight can be from 1 gsm to 20 gsm. The filler amounts can range from 10% to 80% of the dry mass. In another example, the filler amount can be from 10% to 50%.

For dye or pigmented inks which do not contain latex, the ink receiving layer composition can include a porous coating with components that impart gloss and durability while maintaining image quality. This can include silica or alumina pigment dispersions chemically treated to increase image quality and dispersion stability. The treatments can include pH modifiers and small molecules to modify the pigment surface. The ink receiving layer can also include wetting agents, de-foaming agents, and rheology modifiers to increase coating adherence and uniformity. The ink receiving layer can also include binders such as polyacrylates, polyvinyl alcohols, resins, polyols, and so on. The ink receiving layer can also include natural or synthetic elastomers such as styrene butadiene, natural rubbers, polyurethanes, neoprenes, polyisoprenes, polyacrylates, and so on, with a Tg below 120° C. to impart flexibility, coating durability, and coating uniformity to the embossed image. In some cases, the ink receiving layer can also include physical or chemical absorbing agents which modify the thermal properties or radiative absorption of the ink receiving layer.

In some examples, a heater can be used to heat the coated print medium. This heating can be in addition to the heat generated by radiation absorbing agents converting the 200 nm to 400 nm radiation to heat. In some cases, the use of a heater to compliment the irradiation can result in an overall better energy efficiency of the embossing process. The efficiency of converting radiative energy in this wavelength band into thermal energy is complicated by three general issues. First, these wavelengths are high energy wavelength within the electromagnetic spectrum and inherently will require more electrical energy to produce compared to other light sources. Light emitting diodes (LED's) tailored to specific wavelengths are very efficient compared to their fluorescent counterparts, but there is still room for improvement above the 20-40% efficiency currently in the market. Second, the efficiency of absorption by the ink and/or coating is limited by the amount of radiative energy penetration, with some light being reflected or refracted away from the desired location, as well as the degree of overlap between the wavelength(s) produced by the radiation emitter with the excitation states of the absorbing components. Finally, the dissipation of energy by the excited radiation absorbing components as heat (i.e. kinetic energy) may be reduced by competing processes such as conversion of a molecular structure into a higher energy state (a chemical reaction/ionization) or emission of some of the energy as lower energy radiation (fluorescence).

The overall energy efficiency of embossing can be increased by using a heater such as an air dryer, oven, infrared oven or lamp to partially heat the print medium. Heating the material to a temperature closer to, but below, the minimum expansion temperature of the thermal expansion agent with an oven, dryer, or IR source will reduce the total energy to generate 200 nm to 400 nm radiation to induce the expansion of the expanding coating. In some examples, the heater can evenly heat both areas of the coated print medium that have been printed with the enhancing fluid or a colored ink, as well as areas that are unprinted. Thus, the heater can be used to heat the coated print medium to a temperature that is below the minimum expansion temperature so as not to induce unwanted expansion in unprinted areas. The remaining heat for causing expansion in the printed areas can be provided by a radiation emitter as described above.

In some examples, the heater can be used to heat the coated print medium to a temperature from 5° C. to 90° C. below the minimum expansion temperature. In certain examples, the heater can include a dryer or oven. As used herein, a “dryer” or “oven” may refer to any heating apparatus that transfers heat to the material via conduction or convection. In this case the source of heat for such an apparatus may be in the form of electrical energy that produces heat via passing current through a resistive material. Alternatively, the source of heat may come from combustion of a flammable material including, but not limited to; methane, natural gas, gasoline or other volatile hydrocarbons, etc. In some examples, the dryer or oven can be placed to heat the coated print medium immediately prior to irradiation with 200 nm to 400 nm radiation, and minimize the loss of heat which may occur between these heating processes. In certain examples, the dryer already incorporated into many commercial printers can be used as the heating source which compliments the irradiation. In other examples, the expansion process may occur outside of the printer via a standalone dryer/oven and radiation emitter.

In other examples, the heater can include an IR source such as an IR lamp, an array of IR lamps, or an IR oven. In some examples, the IR source can be placed immediately prior to the radiation emitter, in a similar manner to that described for a dryer or oven. Also, the IR source may be a standalone component or a component already existing in commercially available printing technologies. In yet other examples, the IR source and radiation emitter may be incorporated into a single unit, or any configuration by which the coated print medium may be irradiated with both IR and 200 nm to 400 nm band radiation simultaneously. For example, an IR source can be located on one side of the coated print medium and the radiation emitter can be located on the opposite side of the medium. In a specific example, an IR source can be located above the coated print medium and the radiation emitter can be located below the medium. The IR source can be located to heat the coated print medium at the same time as the radiation emitter irradiates the opposite side.

In some cases, the expanding coating layer can be used for enhancing the appearance of graphic images by producing an embossed effect at desired locations. In this application the thermal treatment via irradiation and the alternate heating source used to cause embossing can occur either before or after the visible image is printed. For example, a visible image can be printed using colored ink on the coated print medium. A radiation absorbing ink can be printed either on the same side of the medium as the visible image, or on the opposite side. The coated print medium can then be heated using the heater and a radiation emitter can selectively heat the areas printed with the radiation absorbing ink to form an embossed pattern. In alternative examples, the embossed pattern can be formed before printing a visible image. The visible image can then be printed over the embossed pattern by printing colored ink onto the embossed medium.

In some examples, an IR source and a 200 nm to 400 nm radiation emitter can be set up in an array or scanning configuration. The term “array” refers to the placement of multiple radiation sources in a stationary configuration which allows the full width of the print medium to be irradiated at once while the print medium is moving under the array. The term “scanning” refers to the placement of radiation sources which move across the full width of the print medium while the print medium is stationary or moving. In certain examples, the radiation emitter and/or IR source can be located in a carriage together with an inkjet printhead to print the radiation absorbing ink or colored ink.

The temperature to which the complimentary heater heats the coated print medium can be below the minimum expansion temperature of the thermal expansion agent in the expanding coating layer. In various examples, the heating temperature can be from 5° C. to 90° C. below the minimum expansion temperature. For example, if the heater heats the print medium prior to the radiation emitter irradiating the print medium, then the entire print medium can be heated to a temperature that is 5° C. to 90° C. below the minimum expansion temperature prior to irradiation and then the irradiation can selectively heat the areas printed with radiation absorbing ink up to the minimum expansion temperature or higher. In examples where the heating and irradiation are performed simultaneously, the heater can heat unprinted areas up to a temperature from 5° C. to 90° C. below the minimum expansion temperature while the irradiation selectively heats the areas printed with radiation absorbing ink up to the minimum expansion temperature or higher. The precise heating temperature can be selected to optimize the energy efficiency of the entire embossing process while also ensuring that no unintended embossing occurs outside the areas printed with radiation absorbing ink. In certain examples, the heating temperature provided by the heater can be from 20° C. to 180° C.

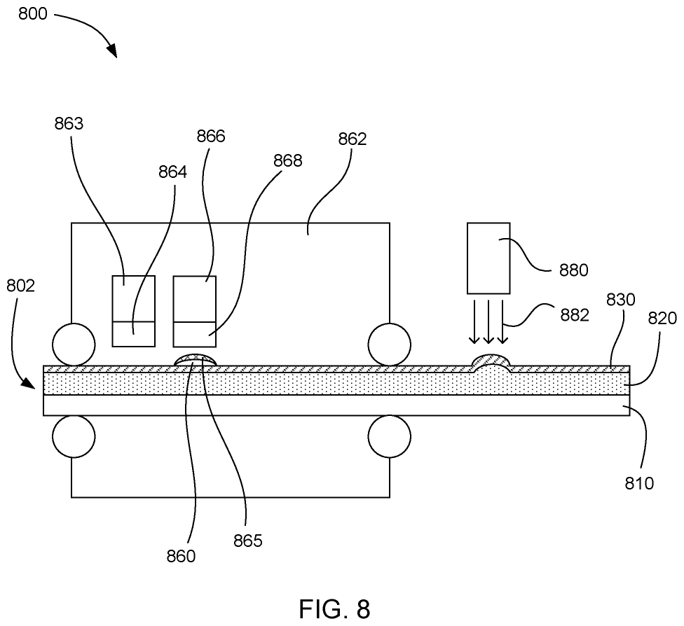

The present disclosure also extends to printing systems that use the coated print media described above. FIG. 8 shows an example printing system 800. The system includes a printer 862. The printer has a reservoir 863 of an enhancing fluid 860, where the enhancing fluid includes an absorbing agent capable of converting radiation having a wavelength from 200 nm to 400 nm to heat. The printer also has a first printhead 864 in communication with the reservoir of enhancing fluid to print the enhancing fluid. The system further includes a reservoir 866 of colored ink 865 and a second printhead 868 in communication with the reservoir of colored ink to print the colored ink. The enhancing fluid and colored can thus be printed on the same print medium. In the example shown, the first and second printhead are both positioned to print on a front surface of the print medium. However, in other examples, the first and second printheads can be on opposite sides of the print medium to print the enhancing fluid and the colored ink on opposite surfaces of the print medium. The system further includes a radiation emitter 880 having a peak wavelength from 200 nm to 400 nm, and a coated print medium 802 to load in the printer. The radiation emitter is positioned to expose a surface of the coated print medium to radiation 882 after the enhancing fluid is printed on the coated print medium. The coated print medium includes a print substrate 810, an expanding coating layer 820 on the print substrate, and an ink receiving layer 830 on the expanding coating layer.

In some examples, the first printhead and the radiation emitter can both be located on the same side of the print medium. That is, if the first printhead is positioned to print enhancing fluid on a front surface of the print medium then the radiation emitter can be positioned to irradiate the front surface. If the printhead is positioned to print enhancing fluid on a back surface of the print medium then the radiation emitter can be positioned to irradiate the back surface. In some examples, the first and second printheads can be positioned on the same side of the print medium. In other examples, the second printhead can be positioned to print color ink on a front surface of the print medium, and the first printhead can be positioned to print enhancing fluid on the back surface of the print medium. In this example, the radiation emitter can be positioned to irradiate the back surface of the print medium. In further examples, the printer can be designed for duplex printing and the coated print medium can include two expanding coating layers and two ink receiving layers, one on either side of the medium. In this example, the printer can include two enhancing fluid printheads on either side of the print medium and two radiation emitters can be used to irradiate both sides of the print medium.

In certain examples, the radiation emitter and/or heater can be separate components from the printer. For example, in roll-to-roll printing systems, a continuous roll, or web, of coated print medium can travel past a printer first, followed by a heater and radiation emitter. In other examples, the radiation emitter and/or heater can be integrated as a part of the printer. In some examples, the printer can be designed to print on individual sheets of print media. This configuration may be used in printers for the home or office. Such a printer can include the printhead for printing radiation absorbing ink, the heater for heating the print media, and the radiation emitter for embossing the surface of the print media.

In some examples, the enhancing fluid can be colorless or nearly colorless. In other examples, the enhancing fluid can have a visible color. In certain examples, enhancing fluids having a visible color can be used for printing on an opposite surface of the print medium from the colored inks used to print the graphic image. For example, the enhancing fluid can be printed on the back of the print medium and the colored inks can be printed on the front of the print medium. However, in examples that involve a colorless or nearly colorless enhancing fluid, the enhancing fluid can be printed on the same surface as the graphic image without interfering with the appearance of the image.

In further examples, the enhancing fluid can include an absorbing agent in an aqueous vehicle. The term “absorbing agent” may be defined as any substance which absorbs radiation and thermally dissipates the absorbed energy within the coating. In some examples, the absorbing agent can specifically absorb radiation having a wavelength from 200 nm to 400 nm. In other examples, the absorbing agent can also absorb infrared radiation. Examples of absorbing agents can include pigments such as TiO₂, carbon black, and so on; conjugated small molecules such as dyes, colored pigments, UVA absorbers such as bisoctrizole, avobenzone, bisdisulizole disodium, diethylamino hydroxybenzoyl hexyl benzoate, and so on; optical brighteners, benzotriazoles, benzophenones, and triazines, and so on. The enhancing fluid can contain one or combinations of these absorbing agents. The term “aqueous vehicle” can refer to water, or a mixture of water and some water soluble, or partially water soluble solvent or an organic co-solvent. The aqueous vehicle may contain non-volatile glycol ether co-solvents, non-ionic surfactants, as well as anionic and cationic surfactants, humectant solvents in addition to water.

Examples of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like.

Examples of non-ionic surfactants include acetylenic surfactants, such as acetylenic diols, alkoxylated acetylenic diols, and other acetylenic surfactants. Some specific examples include 2,7-dimethyl-4-octyn-3,6-diol, 7-tetradecyn-6,9-diol, 2,4,7,9-tetramethyl-5-decyne-4,7-diol, 1,4-dimethyl-1,4-bis(2-methylpropyl)-2-butyne-1,4-diyl ether, ethylene or propylene oxide condensates thereof, or a combination thereof. Some suitable commercially available acetylenic surfactants include Surfynol® and Dynol® surfactants available from Air Products. Examples of non-ionic surfactants can include Surfynol® SE-F, Dynol® 360, Surfynol® S104, Surfynol® S440, Surfynol® CT-211, or a combination thereof (all available from Air Products & Chemicals Inc., Pennsylvania). In another example, the non-ionic surfactant can include, Surfynol® SE-F, Surfynol® S440, or Surfynol® CT-21 1. In yet another example, the non-ionic surfactant can include Dynol® 360. Nonionic surfactants may also include phosphate surfactants, which can be a phosphate ester of fatty alcohols or fatty alcohol alkoxylates. In one example, the surfactant can be a mixture of mono- and diesters, and may have an acid number ranging from 50 to 150. In another example, the phosphate-containing surfactant can be of the Crodafos® family. Specific examples include oleth-3 phosphate, oleth-10 phosphate, oleth-5 phosphate, dioleyl phosphate, ppg-5-ceteth-10 phosphate, Cg-Cis alkyl monophosphate, deceth-4 phosphate, and mixtures thereof. Other specific examples by tradename include Crodafos® N3A, Crodafos® N3E, Crodafos® N10A, Crodafos® HCE, Crodafos® SG, Arlantone® Map 950, Monofax® 83 i, Monofas® 1214, Monalube® 215, and Atlox® DP13/6. Additional examples of surfactants can include TRITON™ surfactants available from Dow Chemical, IGEPAL™ available from Solvay, SILWET™ surfactants available from Momentive Performance Materials, TERGITOL™ surfactants available from Dow Chemical, BRIJ™ available from Croda, PLURONIC™ surfactants available from BASF, FLUORAD™ surfactants available from 3M, ZONYL™ surfactants available from DuPont, NEODOL™ surfactants available from Shell, and combinations thereof. The enhancing fluid can include one or a combination of multiple of these surfactants.

Colored inks can include colorants such as dyes or pigments in a variety colors. Colored inks can include black ink, cyan ink, magenta ink, yellow ink, and a variety of other colored inks. In some examples the colored inks can also include an absorbing agent such as carbon black, titanium dioxide, colored pigments or dyes, conjugated small molecules or polymers, bisoctrizole, avobenzone, bisdisulizole disodium, diethylamino hydroxybenzoyl hexyl benzoate, a benzotriazole, a benzophenone, a triazine, other optical brighteners, or combinations thereof.

Other ingredients in colored inks can include a liquid vehicle, a colorant, a binder, a surfactant, additives to inhibit the growth of microorganisms, viscosity modifiers, materials for pH adjustment, sequestering agents, anti-kogation agents, preservatives, and the like. In some examples, the liquid vehicle can be an aqueous liquid vehicle that includes water and optionally a co-solvent. In further examples, the binder can include a polyurethane or a film-forming latex.

The radiation emitter can include a lamp, laser, or array of LED's. In some examples, the radiation emitter can produce a minimum peak irradiance of 10 W/cm² at the embossing surface. Greater irradiance can be helpful to control emission energy and production speed to reduce potential hazards. In certain examples, the radiation emitter can be a lamp that produces wavelengths between 200-400 nm. The minimum irradiance of 10 W/cm² can occur at a wavelength that overlaps with the absorption peak of the printed radiation absorbing ink. Examples of lamps that can be used include, but are not limited to, gas discharge lamps such as mercury, iron iodide, or gallium iodide or a combination of these that are excited by an electric arc or microwave radiation. Commercially available lamps of this type can include the AMBA® & Light Hammer™ product lines available from Heraeus Inc.

In other examples the radiation emitter can include an array of LEDs. Again, the minimum peak irradiance at the material surface can be no less than 10 W/cm², and the peak irradiance wavelength of the radiation emitter can overlap with the absorption spectrum of the radiation absorbing ink. In one example, the peak wavelength of the LEDs and the peak absorption wavelength of the radiation absorbing ink can be from 200 nm to 400 nm. In certain examples, the LEDs can have a peak wavelength from 365 nm to 400 nm. Examples of useful LED systems include, but are not limited to; FireJet™ FJ100, FireJet™ FJ200, FireJet™ FL400, FirePower™ FP300, etc. from Phoseon Technology Inc. Many of these systems have a peak irradiance greater than 10 W/cm², at wavelengths including, but not limited to 365 nm, 385 nm, and 395 nm.

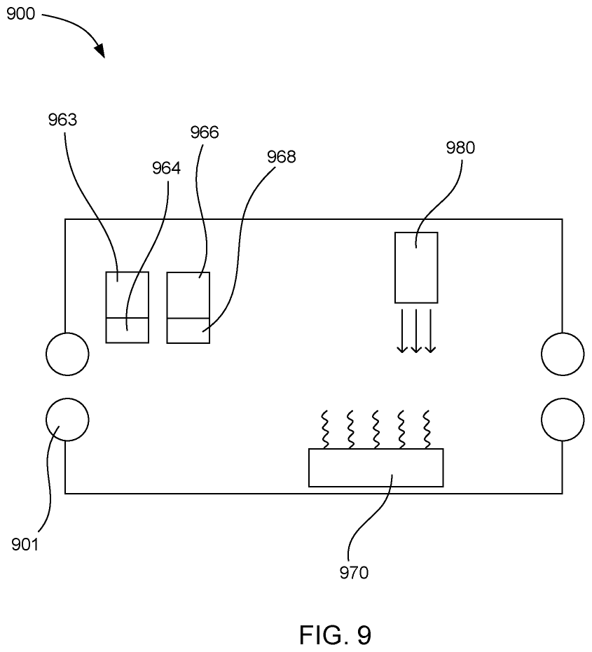

The present disclosure also extends to printers that can be used to print and emboss according to the process described herein. FIG. 9 shows an example printer 900 that includes a reservoir 963 of an enhancing fluid. The enhancing fluid can include an absorbing agent capable of converting radiation having a wavelength from 200 nm to 400 nm to heat. A first inkjet printhead 964 can be in communication with the reservoir to print the ink. The print can also include a reservoir 966 of colored ink and a second printhead 968 in communication with the reservoir of colored ink. A media feeder 901 can be positioned to feed a print medium through a print path of the inkjet print heads. A radiation emitter 980 having a peak wavelength from 200 nm to 400 nm can be positioned to irradiate the print medium after the ink is printed on the print medium. A heater 970 can be positioned to heat the print medium. In this example, the heater is positioned to heat the print medium simultaneous with the radiation emitter irradiating the print medium. In other examples, the heater can be positioned to heat the print medium immediately prior to the radiation emitter irradiating the print medium.

In some examples, the heater and radiation emitter can be static devices that do not move across the surface of the print medium. The print medium can be fed past the heater and the radiation emitter, and the heater and radiation emitter can have a sufficient width that they can heat and irradiate the entire width of the print medium passing by. In examples where the heater or radiation emitter are not physically as wide as the print medium, they can still emit a sufficient width of energy (i.e., heat or radiation) that they can heat and irradiate, respectively, the width of the print medium. In alternative examples, the heater and/or radiation emitter can be moveable and can move along the width of the print medium.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the print media, methods, and systems described herein, each of these discussions can be considered applicable to each of these examples, whether or not they are explicitly discussed in the context of that example. Thus, for example, in discussing details about the print media, such discussion also refers to the methods and systems, and vice versa.

### EXAMPLES

A series of coated print media sheets were made, printed, embossed, and tested using the compositions and tests described below. Table 1 shows compositions of two expanding coating layer formulations and one enhancing fluid formulation.

TABLE 1
Coating Compositions (“ECL” = Expanding Coating Layer)

| | | | | Enhancing |
|---|---|---|---|---|
| Ingredient | Ingredient Type | ECL 1 | ECL 2 | Fluid |
| 051 DU 40 ™ | Expanding Beads | 20 | 25 | |
| Tegowet ™ | Wetting Agent | 1 | 1 | |
| Mowiol ™ 18-88 | PVOH/Thickener | 5 | 4 | |
| Genflo ™ 3000 | Latex | 74 | 70 | |
| 2-pyrrolidone | Solvent | | | 19 |
| MPDiol ® Glycol | Co-solvent | | | 9 |
| Nonionic | Surfactant | | | 0.75 |
| Fluorosurfactant | | | | |
| Nonionic Alcohol | Surfactant | | | 0.35 |
| Ethoxylate | | | | |
| Adeka ™ NOL | Absorbing Agent | | | 6.0 |
| UC-3125 | | | | |
| (Bisoctrizole) | | | | |
| Total Parts | | 100 | 100 | 35.1 |

051 DU 40 ™ available from AkzoNobel; Tegowet ™ available from Evonik; Mowiol ™ 18-88 available from Kuraray; Genflo ™ 3000 available from OMNOVA Solutions; MPDiol ® Glycol available from LyondellBasell; Adeka ™ NOL UC-3125 available from Adeka.

The coatings were applied to print substrates at a target coat weight of 40 gsm (grams per square meter) for the expanding coating layers using a hand blade at a viscosity of 6000 cP (centipoise). The enhancing fluid was then applied to the samples of print media by one of two methods: 1) enhancing fluid was filled into a calligraphy pen and then written onto the sample, or 2) enhancing fluid was injecting into a thermal inkjet cartridge and jetted using an HP Web Press test bed. Samples 1 and 2 included ECL 1 and a TiO₂-based enhancing fluid written by calligraphy pen. The enhancing fluid was applied to the back of Sample 1 and to the front of Sample 2. Samples 3 and 4 included ECL 2 and the enhancing fluid of Table 1 printed by the Web Press test bed. Sample 3 included a thinner substrate and Sample 4 included a thicker substrate. The samples were embossed by exposing the samples to an LED lamp having a peak wavelength of 395 nm. The “heat condition” refers to running the LED lamp at 10 volts (10 V) with a printing speed of 5 feet per minute (5 fpm) and running the media through for number of passes (2×, 3×, etc.). The embossing height was measured by subtracting the unembossed thickness from the embossed thickness as measured by calipers. Table 2 shows the test results.

TABLE 2

| | | | | Unembossed | Embossed | Embossing |
|---|---|---|---|---|---|---|
| Sample | Emboss | Absorbing | Heat | Thickness | Thickness | Height |
| # | from | Agent | Condition | (mm) | (mm) | (mm) |
| 1 | Back | TiO₂ | 10 V/5 | 0.23 | 0.34 | 0.11 |
| | | | fpm/4X | | | |
| 2 | Front | TiO₂ | 10 V/5 | 0.23 | 0.44 | 0.21 |
| | | | fpm/3X | | | |
| 3 | Front | Adeka ™ | 10 V/5 | 0.22 | 0.36 | 0.14 |
| | | NOL UC- | fpm/2X | | | |
| | | 3125 | | | | |
| 4 | Front | Adeka ™ | 10 V/5 | 0.35 | 0.45 | 0.10 |
| | | NOL UC- | fpm/2X | | | |
| | | 3125 | | | | |

The test results show that an enhancing fluid can be applied to a print medium to elicit an embossing effect upon heating with an LED lamp having a wavelength of 395 nm to specifically heat the printed areas. The embossed effect was visible when embossing from the front side (the side on which the expanding coating was applied) or from the back side of the media. The embossing was repeatable on several different media samples.

While the disclosure has been described with reference to certain to examples, various modifications, changes, omissions, and substitutions can be made without departing from the spirit of the disclosure. It is intended, therefore, that the disclosure be limited by the scope of the following claims.

What is claimed is:

1. A radiative embossing method, comprising:
printing an enhancing fluid on a coated print medium to form an enhancing fluid-printed area, wherein the enhancing fluid comprises a colorless radiation absorbing agent capable of converting radiation having a wavelength from 200 nm to 400 nm to heat;
printing a colored ink on the coated print medium to form a visible image, wherein the coated print medium comprises:
a print substrate, and
an expanding coating layer on the print substrate, wherein the expanding coating layer comprises a thermal expansion agent having a minimum expansion temperature; and
irradiating the coated print medium with radiation having a wavelength from 200 nm to 400 nm to selectively heat the enhancing fluid-printed area and expand the thermal expansion agent in the enhancing fluid-printed area.

2. The method of claim 1, wherein the coated print medium further comprises an ink receiving layer on the expanding coating layer, wherein the ink receiving layer comprises either:
a first crosslinked polymeric network and a second crosslinked polymeric network that is a different polymer from the first crosslinked polymeric network, or
inorganic pigment particles and a binder comprising polyvinyl alcohol.

3. The method of claim 1, wherein the colorless radiation absorbing agent, includes bisoctrizole, avobenzone, bisdisulizole disodium, diethylamino hydroxybenzoyl hexyl benzoate, a benzotriazole, a benzophenone, a triazine, other UVA absorbing agents, or combinations thereof.

4. The method of claim 1, further comprising heating the coated print medium using a heater such that the enhancing fluid-printed area and unprinted area reach a first temperature from 5° C. to 90° C. below the minimum expansion temperature of the thermal expansion agent prior to irradiating.

5. The method of claim 1, wherein the expanding coating layer further comprises a flexible polymeric binder and the thermal expansion agent comprises temperature responsive thermoplastic beads in the flexible polymeric binder, wherein the temperature responsive thermoplastic beads comprise a propellant encapsulated in a thermoplastic polymer shell.

6. The method of claim 5, wherein the thermoplastic polymer shell has a glass transition temperature from 90° C. to 200° C. and wherein the flexible polymeric binder has a glass transition temperature below the glass transition temperature of the thermoplastic polymer shell.

7. The method of claim 5, wherein the propellant is a hydrocarbon liquid having a boiling point from 90° C. to 200° C.

8. The method of claim 1, wherein the expanding coating layer is on a front surface of the coated print medium, and wherein the enhancing fluid and colored ink are both printed on the front surface of the coated print medium prior to the irradiating of the coated print medium.

9. The method of claim 1, wherein the expanding coating layer is on a front surface of the coated print medium, and wherein the enhancing fluid is printed on the front surface and the coated print medium is irradiated prior to printing the colored ink, and wherein the colored ink is printed on the front surface after the thermal expansion agent in the enhancing fluid-printed area has expanded.

10. The method of claim 1, wherein the enhancing fluid is printed on a back surface of the coated print medium and the colored ink is printed on a front surface of the coated print medium, and wherein the irradiating is performed on the back surface of the coated print medium.

11. The method of claim 10, wherein the coated print medium further comprises an enhancing fluid-receiving layer on the back surface but does not include an expanding coating layer on the back surface of the print substrate.

12. A radiative embossing printing system, comprising:
a printer, comprising:
a reservoir of an enhancing fluid, wherein the enhancing fluid comprises a colorless radiation absorbing agent capable of converting radiation having a wavelength from 200 nm to 400 nm to heat,
a reservoir of a colored ink,
a first print head in communication with the reservoir of enhancing fluid,
a second print head in communication with the reservoir of colored ink; and
a radiation emitter having a peak wavelength from 200 nm to 400 nm; and
a coated print medium to load in the printer, wherein when the coated print medium is loaded in the printer, the radiation emitter is positioned to expose a surface of the coated print medium to the radiation after the enhancing fluid is printed, and wherein the coated print medium comprises:
a print substrate, and
an expanding coating layer on the print substrate, wherein the expanding coating layer comprises a thermal expansion agent having a minimum expansion temperature.

13. The system of claim 12, further comprising a heater to heat the coated print medium to a first temperature from 5° C. to 90° C. below the minimum expansion temperature of the thermal expansion agent.

14. A radiative embossing printer, comprising:
a reservoir of an enhancing fluid, wherein the enhancing fluid comprises a colorless radiation absorbing agent capable of converting radiation having a wavelength from 200 nm to 400 nm to heat;
a reservoir of a colored ink;
a first inkjet print head in communication with the reservoir of enhancing fluid;
a second inkjet print head in communication with the reservoir of colored ink;
a media feeder positioned to feed a print medium through a print path of the inkjet print heads; and
a radiation emitter having a peak wavelength from 200 nm to 400 nm positioned to irradiate the print medium after the enhancing fluid is printed on the print medium.

15. The printer of claim 14, further comprising a heater positioned to heat the print medium prior to or concurrent with the irradiating of the print medium.
